(19) United States
(12) Patent Application Publication
(10) Pub. No.: US 2015/0121189 A1
(43) Pub. Date: Apr. 30, 2015

(54) Systems and Methods for Creating and Displaying Multi-Slide Presentations

(71) Applicant: Promethean Limited, Blackburn (GB)

(72) Inventors: Ben Titterington, Preston (GB); Andrew Edwardson, Bradford (GB); Andrew Pennington, Manchester (GB); Andrew Button, Blackburn (GB)

(73) Assignee: Promethean Limited, Blackburn (GB)

(21) Appl. No.: 14/065,001

(22) Filed: Oct. 28, 2013

(51) Int. Cl. G06F 3/0484; G06F 17/24

(52) U.S. Cl. CPC G06F 3/04847; G06F 17/241
USPC 715/230; 715/732

(57) ABSTRACT

A computer system for creating and displaying a presentation is disclosed. The computer system may receive a request to generate multiple presentation slides and to associate the slides with a particular background. Later, during a presentation, the system simultaneously displays the slides against the one or more backgrounds within a slide display area. The system may be configured to allow one or more users, during the presentation, to: (1) selectively annotate the slides; (2) save the annotations to memory for future use; (3) independently rotate and/or resize one or more of the first and second slides; (4) remove the first slide from the slide display area independently of the second slide; and/or (5) add one or more additional slides to the slide display area.

### BACKGROUND

Current presentation software packages (and related systems) typically allow a presenter to create and display a series of pre-set, static slides to one or more audience members during a presentation. While such presentation software may be useful, the presenter may desire more dynamic and effective tools to engage their audience and to help communicate their message.

Various embodiments of the present systems and methods recognize and address the foregoing considerations, and others, of prior art systems and methods.

### SUMMARY

A computer system, according to various embodiments, includes at least one processor and memory that is operatively connected to the at least one processor, and is configured to enable a user to create a presentation. In particular embodiment, the system is configured for: (1) accessing a presentation that includes both a first slide and a second slide, the first and second slides each defining a respective object display area, and each being adapted to selectively display a plurality of different multimedia objects within its respective object display area; (2) receiving a display request, from a user, to display the first and second slides in a common slide display area of the presentation; (3) at least partially in response to receiving the display request, simultaneously displaying the first and second slides within the presentation's slide display area; and (4) optionally, while displaying the first and second slides within the slide display area, allowing a user to annotate the first and second slides.

In particular embodiments, the system may be configured for, while displaying the first and second slides within the slide display area, allowing a user to take an action selected from a group that includes: (a) independently rotating and/or resizing one or more of the first and second slides; (b) removing the first slide from the slide display area independently of the second slide; and (c) adding one or more additional slides to the slide display area.

It should be understood, in light of this disclosure, that any of the above steps may also be completed within a computer-implemented method, or by at least one processor within the context of a computer system. Various embodiments may also include a non-transitory medium storing computer-executable instructions for executing one or more of the above steps.

### BRIEF DESCRIPTION OF THE DRAWINGS

Various embodiments of a system and method for creating and displaying a presentation are described below. In the course of this description, reference will be made to the accompanying drawings, which are not necessarily drawn to scale, and wherein:

FIG. 1 is a block diagram of an exemplary presentation system in accordance with an embodiment of the present system;

FIG. 2 is a schematic diagram of a computer, such as the presentation computer 15 of FIG. 1, that is suitable for use in various embodiments;

FIG. 3 depicts a flowchart that generally illustrates various steps executed by a presentation module that, for example, may be executed by the presentation computer of FIG. 1;

FIG. 4 depicts a flowchart that generally illustrates various steps executed by a background module that, for example, may be executed by the presentation computer of FIG. 1;

FIG. 5 depicts a flowchart that generally illustrates various steps executed by a preview module that, for example, may be executed by the presentation computer of FIG. 1; and

FIGS. 6-15 show screen displays of various features of the presentation system according to various embodiments.

### DETAILED DESCRIPTION

Various embodiments will now be described more fully hereinafter with reference to the accompanying drawings. It should be understood that the invention may be embodied in many different forms and should not be construed as limited to the embodiments set forth herein. Like numbers refer to like elements throughout.

### Overview

A computer system, according to various embodiments, is configured to enable a user to create and display a presentation. In various embodiments, the computer system enables the user to first create a series of slides for a presentation and then later display each slide of the series of slides individually, and/or simultaneously with at least one other slide of the series of slides.

In particular embodiments, the computer system enables the user to associate a background with at least one slide of the series of slides. The system may then display the slide (or slides) against at least a portion of the selected background within the presentation display area (which also may be referred to as a slide display area). In particular embodiments, the computer system is configured to display a preview of the background and each of the series of slides in a preview area, where the preview of the background and the preview of each of the series of slides are each live previews (e.g., the previews change when the background and/or any of the content of the slides change).

As a particular illustrative example, the user may use the system to create a presentation of three slides and then associate a first background with the first two of the three slides, and a second background with the third of the three slides. After the system creates the presentation, the system may display a preview of: (1) the first background; (2) the second background; and (3) each of the three slides in a designated preview area that is outside of (or, in other embodiments, within) the presentation display area. Although slide previews to be displayed within this preview area may be arranged in any order, in a particular embodiment, the slides may be arranged in a sequential order (e.g., from left to right, or from right to left) that at least substantially corresponds to the order in which the slides are to appear within the presentation. The background for any particular series of slides may be displayed within the sequence of slides, for example, in any location that visually associates the background with the sequence of slides that will be displayed against the background. For example, a preview of the background for a first sequence of two slides in a presentation may be located before previews of the slides in the first sequence, and a preview of the background for a second sequence of two slides in the same presentation may be located, within the preview section, between previews of the slides in the first sequence and previews of the slides in the second sequence. This helps the presenter to understand which particular background will be displayed behind the various slides in the sequence.

In particular embodiments, the system may be adapted to automatically change the background against which slides are displayed as the presenter presents the slides. For example, in the particular four-slide example above, the background would change from the first background to a second background when the system advances to display the first slide in the second sequence of slides into the presentation display area, or when the user manually moves that slide into the presentation display area during the course of a presentation.

In various embodiments, the computer system is configured to enable the user to modify each slide of the series of slides during either the creation or presentation of the series of slides. In particular embodiments, the system is configured to enable the user to modify one or more physical attributes of, and/or the content of, any slide in a series of slides by, for example: (1) rotating the slide; (2) resizing the slide; (3) moving the slide relative to the background within the presentation display area; (4) resizing one or more live objects (e.g., multimedia objects) on the slide; (5) rotating one or more live objects on the slide; (6) navigating through one or more live objects on the slide (e.g., navigating through video, one or more webpages, etc.); and/or (7) annotating the slide (e.g., adding text to the slide, drawing one or more shapes over the content of the slide, highlighting one or more portions of the slide, etc.). In various embodiments, the system may be configured to enable a user to make such modifications during the presentation, in real time.

Various implementations of the presentation systems and methods are described below, after a brief discussion of exemplary technical platforms and computer system architecture that may be used, for example, in implementing various embodiments.

### Exemplary Technical Platforms

As will be appreciated by one skilled in the relevant field, the present systems and methods may be, for example, embodied as a computer system, a method, or a computer program product. Accordingly, various embodiments may be entirely hardware or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized including, for example, hard disks, compact disks, DVDs, optical storage devices, and/or magnetic storage devices.

Various embodiments are described below with reference to block diagram and flowchart illustrations of methods, apparatuses (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, a special purpose computer, or other programmable data processing apparatus to produce a machine. As such, the instructions which execute on the general purpose computer, special purpose computer, or other programmable data processing apparatus can direct a computer or other programmable data processing apparatus to function in a particular manner such that the instructions stored in the computer-readable memory produce an article of manufacture that is configured for implementing the functions specified in the flowchart block or blocks.

The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including: a local area network (LAN); a wide area network (WAN); a cellular network; or the connection may be made to an external computer (for example, through the Internet using an Internet Service Provider). These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Example System Architecture

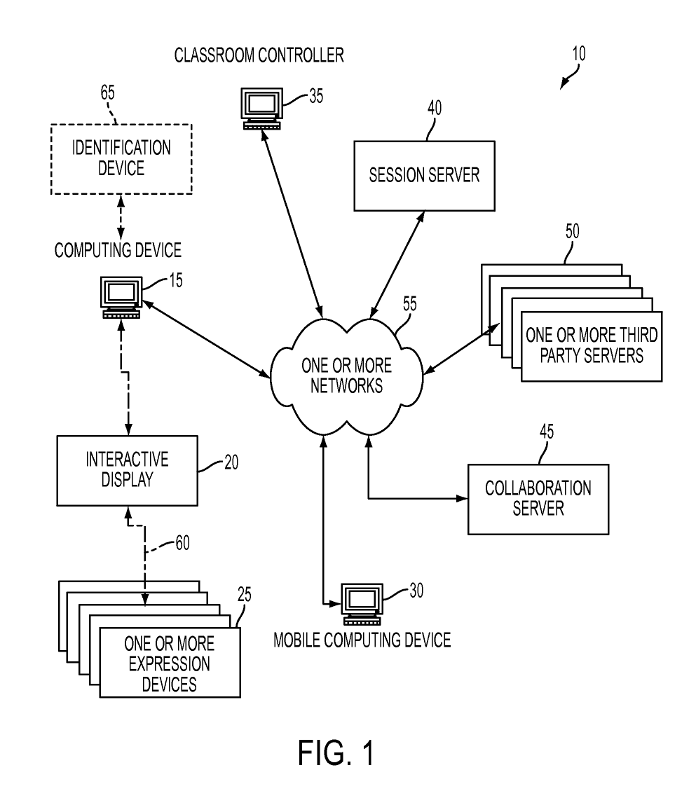

FIG. 1 is a block diagram of a system 10 according to a particular embodiment. As may be understood from this figure, the system 10 includes one or more networks 55. The one or more networks 55 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computers), a local area network (LAN), a wide area network (WAN), a cellular network, and/or the connection may be made to an external computer (for example, through the Internet using an Internet Service Provider).

The one or more networks 55 may be operatively connected to a classroom controller 35 (e.g., a laptop, a tablet, a smartphone, a desktop computer, a wearable computing device, etc.), a session server 40, one or more third party servers 50, a collaboration server 45, one or more mobile computing devices 30 (e.g., a tablet, a smart phone, a laptop, a wearable computing device, etc.), and/or one or more other computing devices such as a presentation computer 15 (which may be, for example, a desktop computer, a laptop computer, a mobile computing device, etc.). In particular embodiments, the one or more computer networks 55 facilitate communication between the classroom controller 35, the session server 40, the one or more third party servers 50, the collaboration server 45, the one or more mobile computing devices 30, and/or the presentation computer 15.

As noted above, the presentation computer 15 may be any suitable computing device. In particular embodiments, the presentation computer 15 is a desktop or laptop computer (or any other suitable computing device). In various embodiments, the presentation computer 15 is operatively connected to the interactive display 20 and optionally to a viewer identification device 65 by a universal serial bus (USB), Wi-Fi, Bluetooth, or any other suitable wired or wireless connection. In particular embodiments, an interactive display 20 (e.g., an interactive whiteboard, smart TV, or other suitable display) may be used as the presentation computer.

The interactive display 20 may be any suitable display device with input/output capabilities. In a particular embodiment, the interactive display 20 is an interactive whiteboard that is touch and/or pen input enabled, such as those produced by Promethean World Plc (Promethean Ltd.). An example of an interactive whiteboard is described in U.S. Pat. No. 8,325,162 to Promethean Ltd., which is incorporated by reference herein in its entirety. It should be understood, in light of this disclosure, that the interactive display 20, in one or more embodiments, is an interactive display other than a whiteboard, such as a computer monitor (which may or may not be touch-enabled), a touch screen computer, an interactive table display, a projector with one or more input sensors, a television operatively connected to one or more motion sensing devices, etc.

The viewer identification device 65 may be any suitable device for identifying one or more viewers of a presentation (e.g., students and/or presentation participants). According to a particular embodiment, the viewer identification device 65 includes a mechanism for visually identifying the one or more viewers (e.g., a camera and facial recognition software, a near field communication device, or any other suitable device that can detect a unique identifier associated with the viewer). In various embodiments, the viewer identification device 65 is a mechanism for identifying a computing device associated with each of the one or more viewers, such as by an IP address and/or device identification code associated with each of the mobile computing devices, which are associated with each of the one or more viewers. In a particular example, the viewer identification device 65 is associated with (e.g., equipped with, connected to, etc.) a near-field communication device that is configured for recognizing a device via Bluetooth, and/or any other suitable protocol.

In various embodiments, one or more input devices 25 are coupled to the interactive display 20 by a wireless connection 60. Such input devices 25 may be adapted to allow one or more of the viewers to communicate data to the system 10 for use in the presentation.

Below is a more detailed discussion of a computing device that may be used, for example, within the system 10 as a suitable presentation computer 15. However, it should be understood that similar computing devices may be used as one or more of the system's other computer components.

In particular embodiments, the presentation computer 15 may be connected (e.g., networked) to one or more other computers via a LAN, an intranet, an extranet, and/or the Internet. As noted above, the presentation computer 15 may operate in the capacity of a server, a client computer in a client-server network environment, and/or as a peer computer in a peer-to-peer (or distributed) network environment. The presentation computer 15 may be a desktop personal computer (PC), a tablet PC, a set-top box (STB), a Personal Digital Assistant (PDA), a cellular telephone, a web appliance, smart TV, an interactive whiteboard, a server, a network router, a switch or bridge, or any other computer capable of executing a set of instructions (sequential or otherwise) that specify actions to be taken by that computer. Further, while only a single computer is illustrated, the term “computer” should also be understood to include any collection of computers that individually or jointly execute a set (or multiple sets) of instructions to perform any one or more of the methodologies discussed herein.

An exemplary presentation computer 15 includes a processor 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processor 202 represents one or more general-purpose processors such as a microprocessor, a central processing unit, or the like. More particularly, the processor 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processor 202 may also be one or more special-purpose processors such as an application specific integrated circuit (ASIC), a field programmable gate array (FPGA), a digital signal processor (DSP), network processor, or the like. The processor 202 may be configured to execute processing logic 226 for performing various operations and steps discussed herein.

The presentation computer 15 may further include a network interface device 208. The presentation computer 15 may also include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker)).

The data storage device 218 may include a machine-accessible storage medium 230 (also known as a non-transitory computer-readable storage medium or a non-transitory computer-readable medium) on which is stored one or more sets of instructions (e.g., software 222) embodying any one or more of the methodologies or functions described herein. The software 222 may also reside, completely or at least partially, within the main memory 204 and/or within the processor 202 during execution thereof by the presentation computer 15—the main memory 204 and the processor 202 also constituting computer-accessible storage media. The software 222 may further be transmitted or received over a network 115 via a network interface device 208.

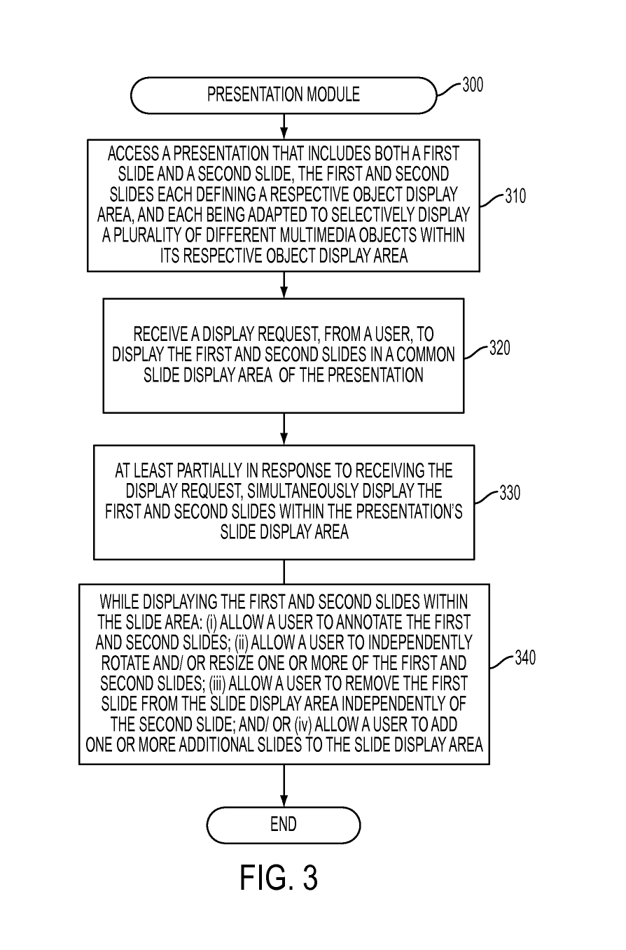

The software 222 may represent any number of program modules, including, but not limited to an operating system (not shown), a lesson builder module (not shown), a presentation module 300, a learner module (not shown), a background module 400, and a preview module 500 (see FIGS. 3-5). It should be understood that these modules are merely exemplary and may represent a number of program modules that control certain aspects of the operation of the presentation computer 15 (or other system computers, or other computers outside the system). The lesson builder module (not shown), presenter module (not shown), learner module (not shown), presentation module 300, background module 400, and preview module 500 are discussed in further detail below.

While the machine-accessible storage medium 230 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium (transitory of non-transitory) that is capable of storing, encoding or carrying a set of instructions for execution by the computer and that cause the computer to perform any one or more of the methodologies of the present system. The term “computer-accessible storage medium” should accordingly be understood to include, but not be limited to, solid-state memories, optical and magnetic media, etc.

### Exemplary System Platform

### Platform Overview

In various embodiments, the system 10 runs one or more slide presentation applications that assist one or more users in creating, displaying, and editing presentations, such as classroom lessons. The applications may include, for example, a presentation module that a presenter (or other individual) may use to create and display a presentation. This module may include one or more sub-modules. One such sub-module is a background module, which the system executes to assist a user in setting up different backgrounds for use in a presentation and later displaying those backgrounds as part of a presentation. Another such system sub-module is a presentation module, which the system executes to assist a user in setting facilitating preview displays of various backgrounds and slides, and in displaying the backgrounds and slides within the course of a presentation.

It should be understood, in light of this disclosure, that various embodiments of the above described system may be used in any suitable presentation setting (e.g., a business setting, a classroom setting, or any other suitable setting). In certain embodiments, the lesson builder module, presenter module, learner module, and any other modules (as further discussed below) may function together to form a presentation application program that enables a presenter to create and present a presentation in a presentation display area that is associated with the presentation application program.

As a brief example, a presenter may set up a presentation for any suitable purpose, for one or more viewers, using the presentation module. The presenter may create a slide presentation that includes multiple backgrounds that are to be displayed in a presentation display area that is associated with the presenter module. The presenter may also create one or more slides and associate each slide with a particular one of the multiple backgrounds. The presenter may then use the system's presenter module to display the presentation. During the presentation, each time a slide is shown in the presentation display area, the background that is associated with the particular slide is shown behind the slide (e.g., the slide is presented against the background associated with the slide) so that the slide appears to lie over the background. This use of customized backgrounds for different groups of slides allows the presenter to give additional meaning to their slides. For example, in a presentation on American history, the presenter may use a Boston Tea Party themed background for all slides related to the formation of the and a Civil War themed background for all slides that are associated with the Civil War. In this way, the backgrounds may help to provide a transition between topics. It should be noted that, in various embodiments, the backgrounds associated with the slides are not backgrounds that are part of the slides. Instead, each background may be an image (e.g., a drawing, picture) or blank background that the system may display in its presentation display area behind one or more of the slides. In various embodiments, a plurality of slides may be presented over a single background substantially simultaneously (e.g., simultaneously) and the user may freely move the slides relative to the background.

### Presentation Module

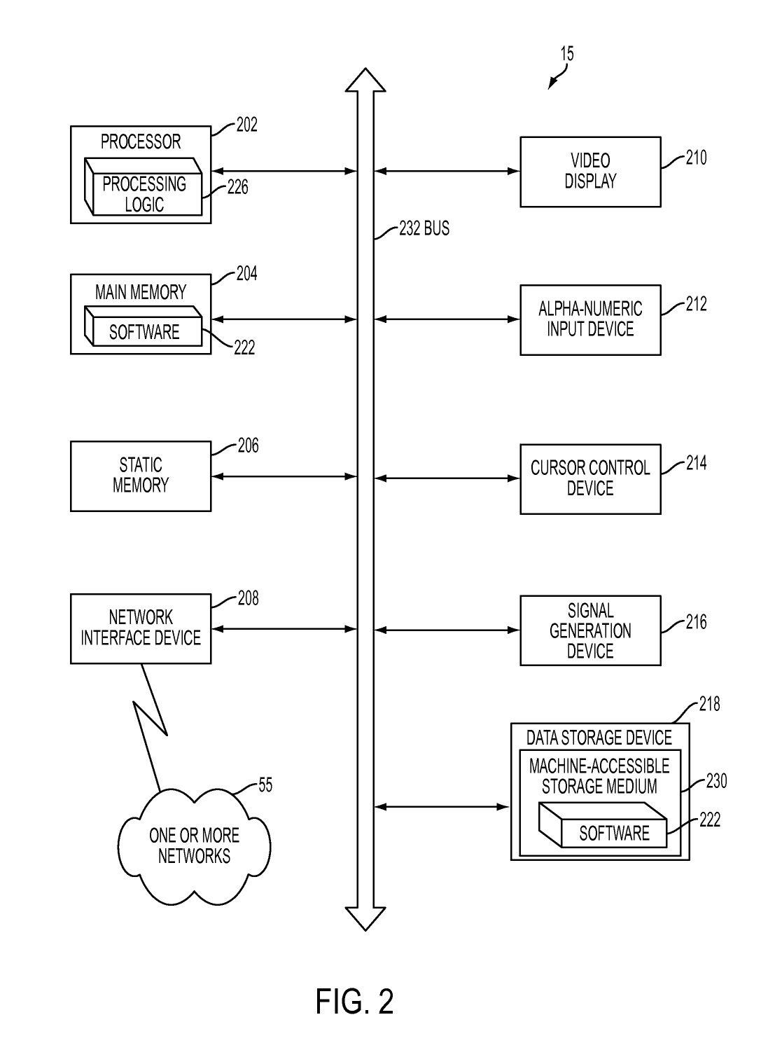

FIG. 3 shows a flow chart of operations performed by an exemplary presentation module 300 that may, for example, be executed by the presentation computer 15 of FIGS. 1 and 2. In particular embodiments, the presentation module 300 may facilitate the display of one or more slides in a common presentation display area of the presentation application program.

When executing the presentation module 300, the system 10 begins, at step 310, by accessing a presentation that includes both a first slide and a second slide. In particular embodiments, the first and second slides each define a respective object display area, and are each adapted to selectively display a plurality of different multimedia objects within its respective object display area.

In particular embodiments, the first slide is one of a first set of slides within the presentation, and the second slide is one of a second set of slides within the presentation. It should be understood that a set of slides (e.g., the first set of one or more slides and/or the second set of one or more slides) may include any suitable grouping of slides. In various embodiments, each set of slides (or “cards”) includes one or more presentation slides of a slide deck. For purposes of this disclosure, the terms “slide” and “card” may be used interchangeably in that the slide or card is a part of a presentation that may be built by adding static or dynamic objects to the slide or card, and the slides or cards are then presented to one or more viewers.

In various embodiments, various slides in the first set and/or the second set may be individual presentation slides and may include static content (content that may not be edited during a particular presentation) and/or dynamic content (content that may be edited during a particular presentation). Such content may include, for example, one or more of the any of the following objects: (1) pictures; (2) pre-recorded videos; (3) streaming live videos (e.g., the content of which may be received from a third party server); (4) live dynamic images of a web site; (5) static images of a web site; (6) drawings; (7) static screen shots; (8) dynamically changing images of the display of one or more computers; (9) text files; (10) audio files that are to be displayed when the slide is displayed in presentation mode; (11) presentation files; (12) working or non-working versions of one or more spreadsheets; or (13) any other suitable content.

In particular embodiments, the system is configured to allow a user to edit the presentation slides while the system is displaying the slides as part of a presentation (e.g., while the slides are being presented as a slideshow). The process of editing the slides during the presentation may involve, for example: (1) annotating one or more of the slides (e.g., the user may draw directly on top of one or more of the slides to add information to the slides); (2) changing the text within one or more of the slides; (3) working with data within one or more of the slides (e.g., modifying the text of a spreadsheet in real time); (4) rotating or resizing the slides themselves or images within the slides; (5) interacting with one or more webpages that are displayed on the slide; or (6) interacting with other live or otherwise dynamic content on the slide).

In addition, the system may be configured to: (1) allow users to add one or more new slides into the presentation while slides are being presented; (2) delete one or more slides from the presentation; (3) change the order of the presentation's slides; and/or (4) display multiple slides together on the same background.

In various embodiments, the slides, when displayed as part of a presentation (e.g., when the presentation application program is in a presentation mode), may be static (e.g., the slides may not be dynamically edited during the presentation). In a particular example, the content of the static slides may be predetermined by a user when the user creates the presentation. Continuing with this example, when the user displays the presentation, the content of the static slides comprises the predetermined content, which cannot be edited during the presentation.

The system 10 may be configured for associating the first set of one or more slides and the second set of one or more slides in memory in any suitable way. In various embodiments, the system 10 is configured for associating the first set of one or more slides and the second set of one or more slides in memory by saving the first set of slides and the second set of slides as part of the same file. In some embodiments, the system is configured for associating the first set of one or more slides and the second set of one or more slides in memory by associating the first set of slides with the second set of slides. In a particular embodiment, the system 10 is configured for associating the first set of one or more slides and the second set of one or more slides in memory by referencing each of the sets within the other set (e.g., the first set of slides contains an internal reference to the second set of slides). In further embodiments, the system 10 is configured for associating the first set of slides and the second set of slides in memory by assigning the first set of slides and the second set of slides a common identifier (e.g., the ID and/or session token discussed above). In still further embodiments, the system may be configured for associating the first set of one or more slides and the second set of one or more slides in memory by saving each of the first set of one or more slides and the second set of one or more slides in a common folder, library, on a common server, etc.

In various embodiments, the first and second sets are configured to be displayed as at least part of the presentation by being at least partially integrated (e.g., integrated) with at least one other slide set that is part of the presentation (e.g., a user presents multiple sets of slides as part of the presentation). In one or more embodiments, the first and second sets are configured to be displayed as at least part of the presentation by being the only sets of slides in the presentation (e.g., the presentation includes only the first and second sets). The presentation may be any suitable presentation of material presented by any suitable user. In various embodiments, the presentation is a lesson presented by a teacher. In one or more embodiments, the presentation is a business presentation presented by an executive (or any suitable business person). According to a particular embodiment, the presentation is a seminar presentation presented by a presenter (e.g., a seminar on self-help or any other suitable topic).

The system 10 continues, at step 320, by receiving a display request, from a user, to display the first and second slides in the presentation display area (also known as a slide display area) associated with the presentation application program. In various embodiments, the system is configured to receive the display request from a computing device associated with the user (e.g., the presentation computer 15, the interactive display 20, the mobile computing device 30, or the classroom controller 35). In various embodiments, the system is configured for receiving the display request from another computing device such as a server (e.g., the session server 40, the collaboration server 45, and/or the one or more third party servers 50).

In one or more embodiments, the presentation display area may encompass substantially all of a particular display screen. In further embodiments, the presentation display area may encompass an area less than the entire display screen. In this embodiment (and others), the presentation display area may be located in any suitable location of a particular display that is associated with the system (or across multiple displays).

At Step 330, at least partially in response to receiving the display request, the system displays the first and second slides simultaneously within the presentation's slide display area (e.g., a predefined area of the display screen where the slides are presented). In various embodiments, the system is configured for displaying the first and second slides by transmitting an image of the presentation display area to a suitable display device (e.g., touch-screen display, a touch screen monitor or TV, etc.). In particular embodiments, the system is configured for projecting the presentation display area onto the interactive display 20 (e.g., an interactive whiteboard, etc.). In various embodiments, the system is configured for displaying the first and second slides on one or more mobile computing devices 30 (e.g., a student's tablet, a business person's smartphone, etc.). In particular embodiments, the first and second slides are simultaneously displayed in the presentation display area of a presentation application program or suitable mobile application, regardless of the device on which the first and second slides are displayed.

It should be understood, in light of this disclosure, that the computer system may be configured to display any number of slides substantially simultaneously (e.g., simultaneously) and/or one at a time. In a particular example, the user sets up a presentation with three slides. Continuing with this example, when the user is presenting the presentation (e.g., when a teacher is presenting a lesson to one or more students), the user may instruct the system to display the first two slides of the three slides of the presentation at the same time in the presentation display area. The user may then instruct the system, in this example, to display the third slide of the three slides without the first two slides being displayed. In another variation of this example, the user instructs the system to display each of three slides separately and in sequence (e.g., the user displays the first slide then provides a command that moves/removes the first slide from the presentation display area and displays the second slide). In still another variation of this example, the user may instruct the system to display all of the three slides at the same time in the presentation display area. In yet other embodiments, the user may instruct the system to begin the presentation by displaying only the first slide of the three slides. During the user's presentation of the first slide, the user may enter a command or select one of the second and/or third slides to be added to the presentation display area. In response to this command or selection, the system then displays the selected second or third slide (e.g., simultaneously with the first slide) within the presentation display area. Thus, the system 10 may allow a user to dynamically present a series of slides to a group of viewers in a dynamic, ever-changing manner depending on many variables that arise in real-time during the presentation without having to move the system out of a presenting mode and into a presentation building mode.

Returning to FIG. 3, at Step 340, while displaying the first and second slides within the slide area, the system: (A) allows a user to annotate the first and/or second slides; (B) allows a user to independently rotate and/or resize the first and/or second slide; (C) allows a user to remove the first slide from the slide display area independently of the second slide; and/or (D) allows a user to add one or more additional slides to the slide display area. Such functionality is discussed in greater detail below.

As discussed above, the system may be adapted to allow one or more users to annotate the first and/or second slides (or other slides) while the system is in a presentation mode and while the slides are in the presentation's slide display area. In particular embodiments, the system may allow the user to make such annotations by moving a pointing device (e.g., a stylus, electronic pen, finger, or any other suitable pointing device) over the surface of a display screen immediately adjacent a portion of the display screen that is displaying the slide to be annotated. The system may then create an annotation that is substantially in the shape of the path of the movement of the pointing device over the display screen. For example, if a user uses a stylus to write an “A” on top of a particular slide displayed on a display screen, the system may show, on the slide, an electronic representation of the “A” that was drawn by the user.

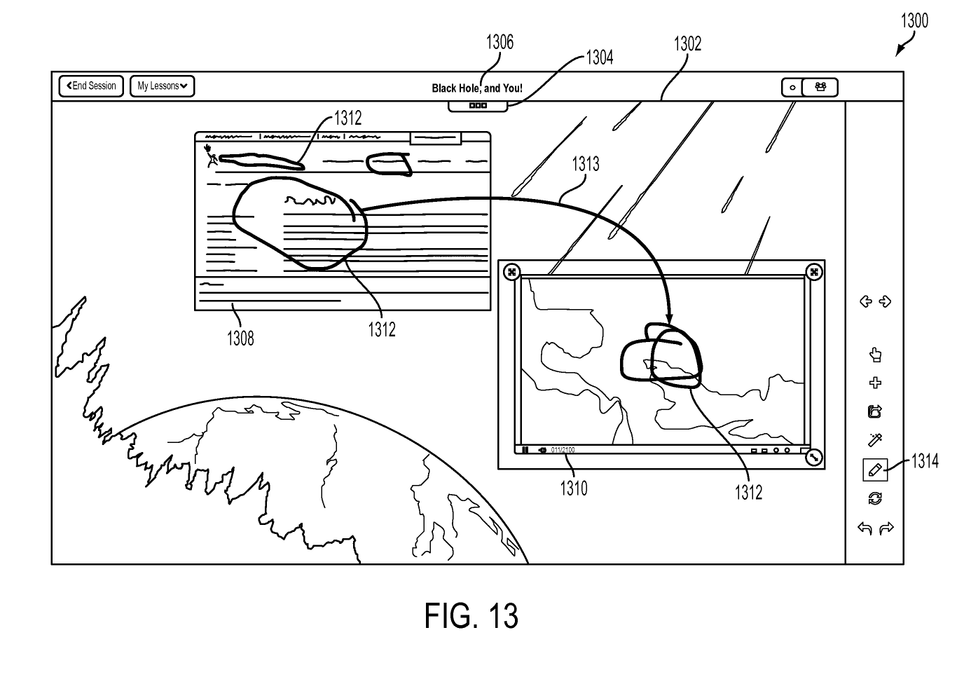

In particular embodiments, the system may be configured to allow a user to annotate multiple slides within the presentation's slide display area (or in any other suitable area, such as a presentation preview area), and to allow multiple users (or the same user) to annotate multiple slides within the slide display area at substantially the same time. Similarly, the system may be adapted to allow one or more users to make one or more annotations within the presentation's display area that extend over a background that is currently displayed in the presentation's display area. For example, as shown in FIG. 13, the system may allow a user to draw a line annotation 1313 that extends over a top surface of a first slide 1308, over a portion of the presentation's background that is between the first slide 1308 and a second slide 1310, and over a top surface of the second slide 1310.

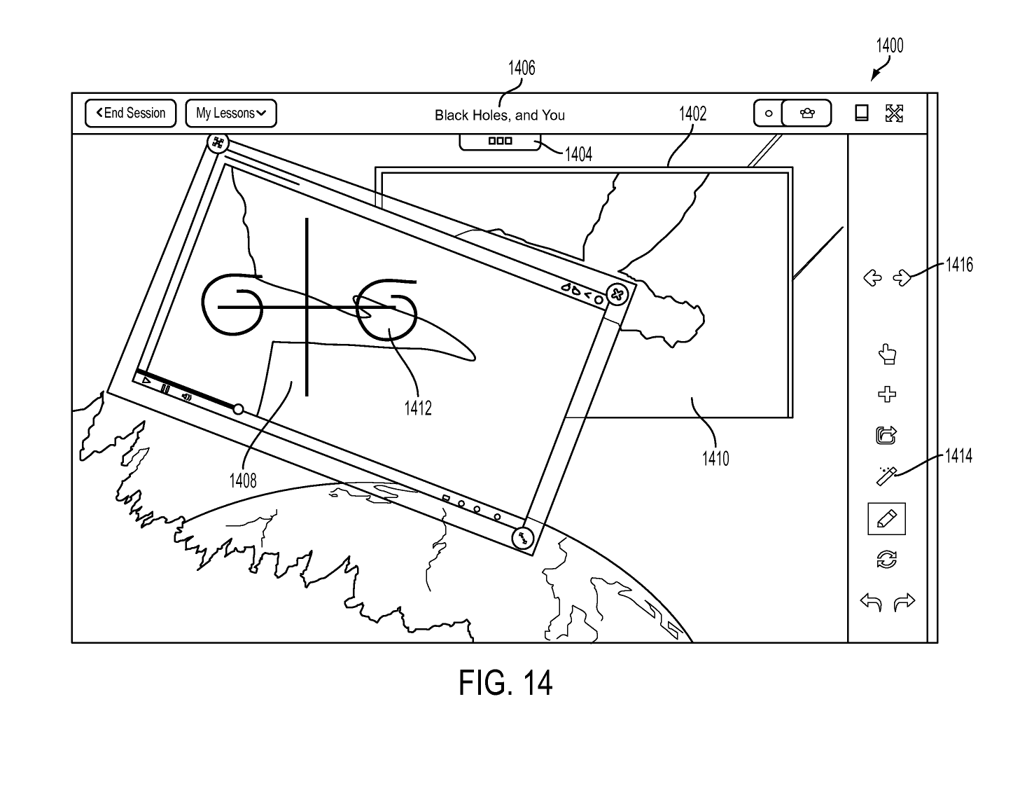

In various embodiments, the system may save annotations to a display layer that may selectively be superimposed over the objects that the annotations serve to annotate. This may allow users to selectively view the annotated objects with or without the annotations. For example, in the example shown in FIG. 14, the system may be adapted to allow the user to save a copy of the annotated slide 1408 for later display in the same presentation or another presentation. In various embodiments, the system may save the slide separately from its respective annotation, or the system may combine the slide and the annotation into a single file (e.g., by the saving each annotation as an object on a slide that the annotation serves to annotate).

Returning to FIG. 13, the system may be configured for selectively saving one or more annotations that extend over multiple slides, as shown in this figure. In certain embodiments, the system may also save the positions of the slides 1308, 1310 relative to the background 1302, so that the system can later reproduce the appearance of the slides 1308, 1310, the annotations, and the background in the same or different presentation. The system may use similar techniques to save the rotational orientation, size, position, zoom characteristics, and/or any other characteristic of one or more slides within a presentation so that the slides may be later displayed in a same or similar state in a later presentation.

As noted above, when displaying the first and second slides, the system may be configured to enable the user to modify the position or other configuration of one or more slides in any suitable way. In a particular embodiment, the system may be configured to enable the user to rotate, move, resize, and/or zoom in/zoom out of the one or more slides during a presentation. For example, while two slides may initially be displayed side-by-side within the system's presentation display area, the user may, in various embodiments, manipulate the slides independently of one another (e.g., the first slide may be rotated clockwise within its current plane by 30 degrees while the second slide is resized and rotated counterclockwise by 15 degrees within its current plane). Furthermore, in addition to modifying the slides, the user may also modify the content of any slide during the presentation of the slides. Thus, the user may, for example, rotate, move, resize, and/or zoom in/zoom out of an object on a slide during a presentation. Additionally, the user may start, stop, pause, fast forward through a video or navigate through one or more webpage objects that are contained on the slide. In various embodiments, videos and/or webpages can also be rotated, resized, etc. during the presentation.

In particular embodiments, the system may be configured to enable a user to exchange one slide of the one or more slides for another slide of the one or more slides during the presentation without leaving the presentation mode (e.g., the system may be configured for enabling the user to change the presentation order of the one or more slides during the presentation). In various embodiments, the system may be configured to enable the user to add and/or delete one or more slides from the presentation during the presentation (e.g., while in a presenting mode). In particular embodiments, the user may add one or more slides to the presentation (e.g., during a presentation) by, for example, dragging a representation of one or more slides from a presentation area into the system's presentation display area. Similarly, in various embodiments, the user may remove one or more slides from the current presentation (e.g., during the presentation, while the system is in presentation mode) by dragging the one or more slides out of the system's presentation display area.

In particular embodiments, the system may be adapted to allow a user to add new slides to the system's presentation display area by dragging a thumbnail representation of the slide from a preview area into the presentation display area. Similarly, the system may be adapted to allow a user to remove slides from a current presentation by dragging the slide from the presentation display area into the preview area. In such a case, the system may: (1) automatically convert the slide from a full-sized slide to a thumbnail representation of the slide when the slide reaches the preview area; and then (2) store the preview

Further functionality of various embodiments of the systems and methods are described below.

### Background Module

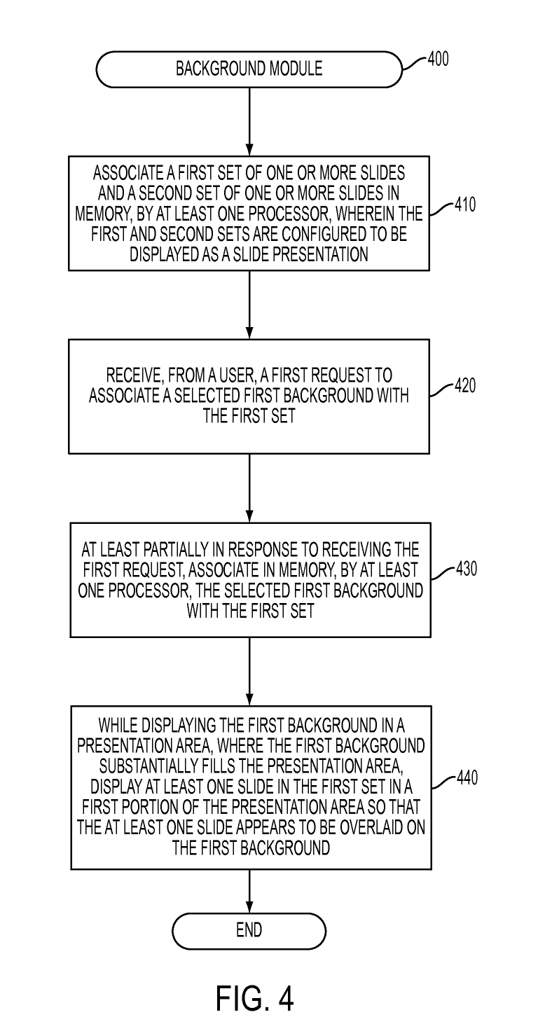

FIG. 4 is a flow chart of operations performed by an exemplary Background Module 400. In particular embodiments, the Background Module 400 may facilitate the display of one or more slides in a common display (presentation) area, where the one or more slides are associated with one or more backgrounds.

When executing the Presentation Module 400, the system begins, at Step 410, by associating a first set of one or more slides and a second set of one or more slides in memory, wherein the first and second sets are configured to be displayed as a slide presentation. In various embodiments, the system is configured to associate the first set of one or more slides and the second set of one or more slides in memory by saving the first set of slides and the second set of slides as part of the same file. In other embodiments, the system is configured to associate the first set of slides and the second set of slides in memory by associating the first set of slides and the second set of slides in any suitable manner (e.g., by referencing each of the sets within the other set, by assigning the first set of slides and the second set of slides a common identifier, etc.).

At Step 420, the system then receives, from a user, a first request to associate a selected first background with the slides in the first set. In various embodiments, the system is configured to receive the first request from a computing device associated with the user (e.g., the computing device 15, the interactive display 20, the mobile computing device 30, and/or the classroom controller 35). In one or more embodiments, the system is configured to receive the first request from another computing device, such as a server (e.g., the session server 40, the collaboration server 45, and/or the one or more third party servers 50).

The first selected background may be any suitable background. In various embodiments, the first selected background is an image or other visual to be displayed in conjunction with one or more slides from the first set and/or the second set. In particular embodiments, the first selected background is a video, .gif file, a JPEG file or any other suitable type of image, or animated file that is configured to play while one or more slides are being displayed. In further embodiments, the first selected background may include an audio file, a file containing text, a live website, etc.

The first selected background may be selected by any suitable party. In various embodiments, the user (e.g., the presenter) selects the first selected background when building the presentation. In a particular embodiment, a third party user creates the presentation and selects the first selected background (e.g., the user who builds the presentation does not present the presentation). In further embodiments, the system is configured for substantially automatically (e.g., automatically) selecting the first selected background based on any suitable factors, including: (1) the content of one or more slides associated with the first selected background (as further discussed below); (2) one or more settings associated with the system (e.g., the system may be configured to find and/or produce backgrounds based on one or more predetermined settings), etc.

At Step 430, the system, at least partially in response to receiving the first request, associates in memory the selected first background with the first set of slides. In various embodiments, the system is configured for associating the selected first background with the first set of slides in any suitable manner.

It should be understood, in light of this disclosure, that the system may be configured to associate any number of sets of one or more slides with any number of backgrounds (e.g., a first set of one or more slides may be associated with a first background, a second set of one or more slides may be associated with a second background, a third set of one or more slides may be associated with a third background, etc.). It should also be understood that more than one set of slides may be associated with a particular background (e.g., the first set of one or more slides and the second set of one or more slides may each be associated with the first background).

At Step 440, while displaying the first background in the presentation display area so that the first background substantially fills the presentation display area, the system displays at least one slide from the first set in a first portion of the presentation display area so that the at least one slide appears to be overlaid on the first background.

In various embodiments, the system is configured for displaying the first background and the at least one slide in the presentation display area by transmitting the first background and the at least one slide to a suitable display device. In one or more embodiments, the system is configured for displaying the first background and the at least one slide in the presentation display area on the interactive display 20 (e.g., an interactive whiteboard, touch-screen display, etc.). In one or more embodiments, the system is configured for displaying the first background and the at least one slide in the presentation display area on the mobile computing device 30 (e.g., a student's tablet, a business person's smartphone, etc.).

### Preview Module

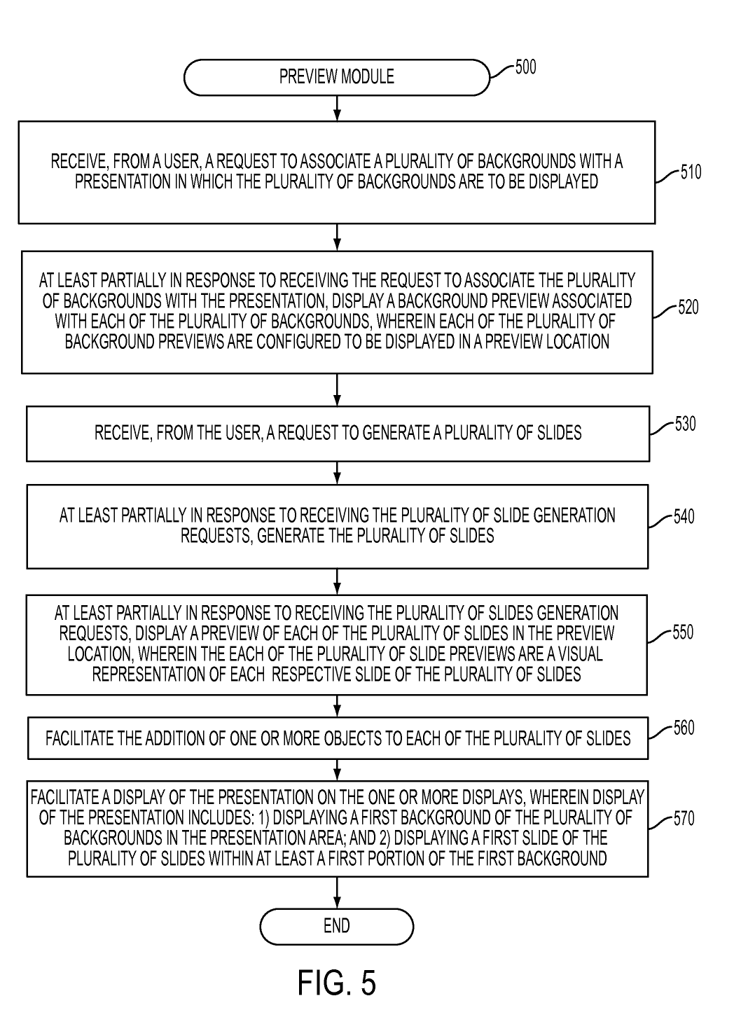

FIG. 5 is a flow chart of operations performed by an exemplary preview module 500. In particular embodiments, the preview module 500 may facilitate the display of one or more slides and one or more backgrounds as thumbnails (or in any other suitable format) in a preview location that is part of the presentation display area. In various embodiments, the thumbnails may be organized and displayed horizontally from left to right (e.g., at least substantially in the order in which they are attended to be displayed in a presentation). In other embodiments, the thumbnails may be organized and displayed vertically from top to bottom (e.g., at least substantially in the order in which they are attended to be displayed in a presentation), or in any other suitable arrangement.

When executing the preview module 500, the system begins, at step 510, by receiving, from a user, a request to associate one or more (e.g., a plurality of) backgrounds with one or more slides in a presentation as described above. In various embodiments, the system is configured for receiving the request from the user via a computing device associated with the user (e.g., the computing device 15, the interactive display 20, the mobile computing device 30, the classroom controller 35, and/or any other suitable computing device). In one or more embodiments, the system is configured for receiving the request from another computing device, such as a server (e.g., the session server 40, the collaboration server 45, the one or more third party servers 50, and/or any other suitable computing device).

In various embodiments, the plurality of backgrounds may be images to be displayed behind one or more associated slides in a presentation display area during building of the presentation (e.g., while the system is in a presentation building mode) and/or during presentation of the slides (e.g., while the system is in a presenting mode). In one or more embodiments, the backgrounds may be videos, .gif or JPEG files, and/or any other suitable files that are configured to play while one or more slides are being displayed. In further embodiments, the backgrounds may be audio files, files containing text, websites, etc. It should be understood, in light of this disclosure, that each of the backgrounds may be a different background (e.g., a first background may be a particular image and a second background may be a particular live video feed).

In various embodiments, the user making the request to associate the backgrounds with the slides may be the presenter of the presentation (e.g., the user that makes the request will present the presentation). In other embodiments, the user making the request to associate the backgrounds with the slides may be a user that creates the presentation, but that does not present the presentation (e.g., the user that makes the request builds the presentation, but another user presents the presentation).

The presentation may be any suitable presentation of material. In various embodiments, the presentation is a lesson presented by a teacher. In other embodiments, the presentation is a business presentation presented by an executive (or any suitable business person). According to a particular embodiment, the presentation is a seminar presentation presented by a presenter (e.g., a seminar on self-help or any other suitable topic).

The system may be configured for associating the plurality of backgrounds with the presentation. In various embodiments, the system is configured to associate the plurality of backgrounds with the presentation in memory by saving the plurality of backgrounds with the presentation as part of the same file. In one or more embodiments, the system is configured for associating the plurality of backgrounds with the presentation in memory by associating the plurality of backgrounds with the presentation or by saving each of the plurality of backgrounds with the presentation in a common folder, library, on a common server, etc.

At Step 520, at least partially in response to receiving the request to associate the plurality of backgrounds with the presentation, the system displays a background thumbnail associated with each of the backgrounds. In various embodiments, each of the background thumbnails is configured to be displayed in a preview location. The background thumbnails may be displayed in the preview location as soon as the user selects the background, or the background thumbnail may be displayed in the preview location once the user selects any slide associated with the background.

Each background thumbnail may be any suitable representation of a respective selected background. In various embodiments, each background thumbnail may be a substantially square, smaller representation of a particular background. In these (and other) embodiments, the thumbnail images may be any size (e.g., a specific ratio of the screen size; a specific ratio of the preview area, which may be adjustable; or a specific set size (e.g., 1 inch by 1 inch square)) and shape (e.g., a rectangle, a circle, an oval, a triangle, a free-form object, or a 3-D object). In various embodiments, each of the plurality of background previews is a non-thumbnail representation of a respective one of the plurality of backgrounds. Such a representation may be, for example, an image or symbol that represents the background, a description of the background, or any other suitable representation.

Each of the background thumbnails may be associated with a respective one of the backgrounds in any suitable way, including any of the ways (or other ways) the backgrounds are associated with the presentation in Step 510. In one or more embodiments, a background thumbnail may be a duplicate of the background that is reduced in size and displayed in the preview location. Thus, the thumbnail may be a live display of the respective background to which it is associated. In a particular example, a background may comprise an animated image of a ship on an ocean (e.g., a looped .gif file or other suitable animated image). Continuing with this example, the background thumbnail associated with the animated background shows the ship moving in the thumbnail as it moves in the background (e.g., when the background is displayed, the ship is animated to rock on the ocean and when the background thumbnail is displayed, the ship in the thumbnail rocks on the ocean at substantially the same time as it rocks in the background).

The preview location may be any suitable area for displaying the background and other thumbnails (e.g., thumbnails of the slides that are part of the presentation). In various embodiments, the preview location is positioned within, over, or adjacent the system's presentation display area. The preview location may be any suitable size and/or shape and may, in various embodiments, encompass any suitable portion of the presentation display area. In particular embodiments, the preview location may not be displayed in the presentation display area (e.g., on the interactive display 20) when the user is presenting the slides. Instead, the preview location may be displayed on a separate display (e.g., on a tablet associated with the user while the presentation and/or presentation setup is displayed on a computer display screen associated with the user).

At Step 530, the system receives, from the user, a request to generate a plurality of slides. In various embodiments, the system is configured to receive the request to generate the plurality of slides in any of the ways (or other ways) that the system is configured to receive the request to associate the plurality of backgrounds with the presentation (see Step 510). The plurality of slides may be any suitable display slides, such as the slides discussed above (e.g., in regard to Step 410).

At Step 540, the system, at least partially in response to receiving the plurality of slide generation requests, generates the plurality of slides. In various embodiments, the system is configured to generate each of the plurality of slides by generating a new object (e.g., a new slide) from a slide prototype (e.g., a slide with predetermined properties). In one or more embodiments, the system is configured to generate each of the plurality of slides as a copy of an original slide file (e.g., the system copies a slide and/or slide file that may or may not be later modified by the user).

Continuing with Step 550, the system, at least partially in response to receiving the generation request for the plurality of slides, displays a preview of each of the plurality of slides in the preview area. In various embodiments, each of the plurality of slide previews is a visual representation of a respective slide of the plurality of slides. The system, in various embodiments, is configured to display the preview of each of the plurality of slides in the preview area generally in any of the ways described above with reference to Step 520.

The system may be configured to display one or more previews in the preview area (e.g., the plurality of background previews and/or the plurality of slide previews) in any suitable way and/or order. In various embodiments, the system may be configured to associate a particular background of the plurality of backgrounds with a particular slide (e.g., as described in regard to Step 430). In these (and other) embodiments, the system is configured to display the particular background preview proximate the particular corresponding slide preview. In one such embodiment, the system is configured to display the background preview immediately adjacent the particular slide preview (e.g., immediately to the left, right, above and/or below the particular slide preview). In another such embodiment, where a first and second particular slide are associated with a particular background, the particular background preview is immediately adjacent the first particular slide preview and the second particular slide preview is immediately adjacent the first particular slide preview (e.g., in the order: particular background preview, first particular slide preview, second particular slide preview).

At Step 560, the system facilitates the addition of one or more objects to each of the plurality of slides. In particular embodiments, the system is configured to facilitate the addition of any one or more objects, such as, for example, text, one or more pictures, one or more animated files, one or more drawings, one or more videos, one or more audio files, one or more PDF files, one or more presentation objects (e.g., one or more objects from a presentation program, such as Microsoft PowerPoint).

The system, in various embodiments, is configured for facilitating the addition of the one or more objects to each of the plurality of slides at any suitable time. In various embodiments, the system is configured to facilitate the addition of the one or more objects to any of the plurality of slides while the user is presenting/displaying the presentation (e.g., in a presentation mode). In one or more embodiments, the system is configured to facilitate the addition of the one or more objects to any of the plurality of slides while the user is setting up the presentation (e.g., in a set-up or builder mode).

Additionally, the system, according to a particular embodiment, is configured for facilitating the addition of particular types of objects to any slide of the plurality of slides. In various embodiments, the system is configured for facilitating the addition of a specific type of object (e.g., a video) to a specific slide of the one or more slides. In one or more embodiments, the system is configured for facilitating the addition of different types of objects (e.g., text and video) to different ones of the plurality of slides.

The system may be configured to facilitate the addition of the one or more objects to each of the plurality of slides in any suitable way. In various embodiments, the system is configured to facilitate the addition of one or more objects to each of the plurality of slides by enabling the user to drag and drop each of the one or more objects on to the slide. In one or more embodiments, the system is configured to facilitate the addition of one or more objects to each of the plurality of slides by enabling the user to add each of the one or more objects to one or more of the slides via an insert command in a menu prompt. It a particular embodiment, the system is configured to enable the user to add one or more objects to a particular one of the plurality of slides using an attachment command (e.g., the user “attaches” each of the one or more objects to a particular one of the plurality of slides), by enabling the user to manually create the one or more objects (e.g., if the one or more objects are text, by entering the text and/or by drawing the one or more objects using any suitable mechanism), etc.

At Step 570, the system facilitates a display of the presentation on the one or more displays, wherein display of the presentation includes: 1) displaying a first background of the plurality of backgrounds in the presentation display area; and 2) displaying a first slide of the plurality of slides against at least a first portion of the first background. In various embodiments, the system is configured to facilitate the display of the presentation on the one or more displays by transmitting the presentation to any suitable display device, such as, for example, the interactive display 20. In a particular embodiment, the system is configured to facilitate the display of the presentation on the one or more displays within a suitable presentation display area, such as (but not necessarily) the presentation display area discussed above in step 440.

### Illustrative Example of Various Features of the Present Systems and Methods

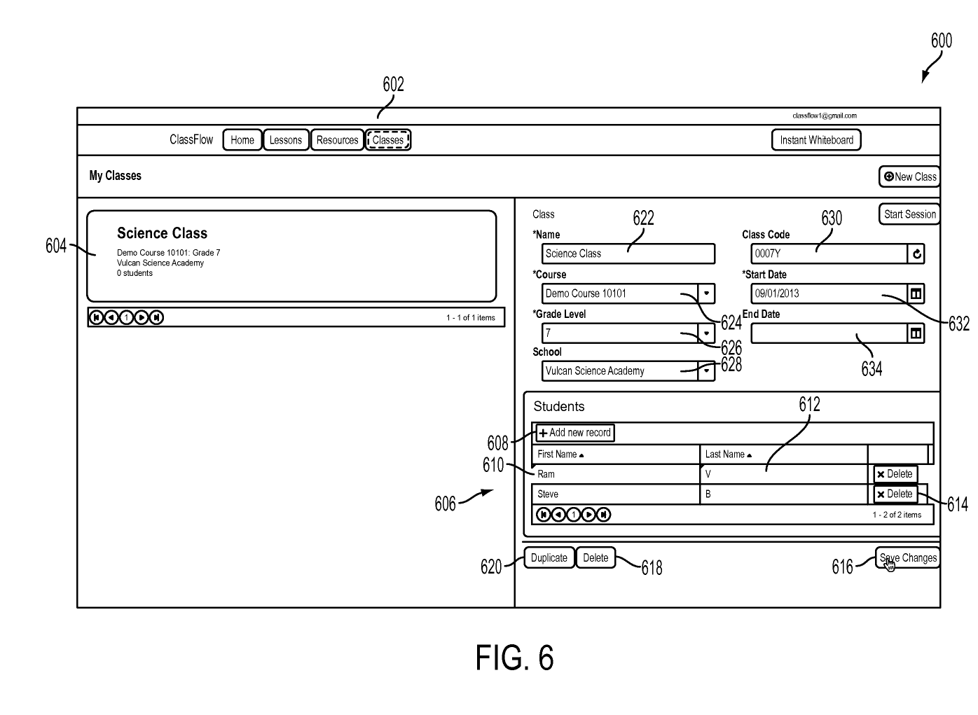

FIGS. 6-15 depict screen shots of various features of the present systems and methods included in various embodiments. In particular, the screen shots of FIGS. 6-15 show how a user (e.g., a teacher or other presenter) may use the system to set up and display a presentation (e.g., lesson) to one or more viewers (e.g., students or other viewers). It should be understood that although the following discussion describes having a teacher set up and present one or more lessons to students, the following examples may apply to any type of presentation in any suitable context.

FIG. 6 depicts a Class Setup Screen 600 for setting up a class (e.g., for a classroom of students, for a series of presentations, for a series of lectures, etc.). The Class Setup Screen 600 includes a plurality of navigation options 602, such as “Home,” “Lessons,” “Resources,” and “Classes.” The navigation options 602 enable a user to navigate to various sections of the program. The Class Setup Screen 600 also includes a Class Identifier Section 604, which displays the current class and several additional details about the current class, such as grade and number of students (e.g., as populated from the class information 608).

The Class Setup Screen 600 includes a student roster 606 section in which a teacher may populate a list of students in the class. The teacher can add students to the student roster 606 using the Add New Record Button 608, which creates a new student record in a database of students. The teacher can then add each student's first name 610 and last name 612. The teacher can delete a student record by using the delete button 614. Additionally, the teacher may duplicate or delete an entire student roster 606 using the duplicate button 620 or delete button 618, respectively. The teacher may, at any time, save changes to the student roster 606 using the save changes button 616.

The teacher may add information about the class, including a name 622 of the class, a course 624 (e.g., a course description, such as “Science”), a grade level 626 (e.g., 7), a school 628, a class code 630, a start date 632, and an optional end date 634. The class code 630 may, in various embodiments, be generated by the system, but may be edited by the teacher (e.g., to remove combinations of letters and numbers that may create an offensive word). The class code 630 is used, in a particular embodiment, by participants to log into the class and/or lesson.

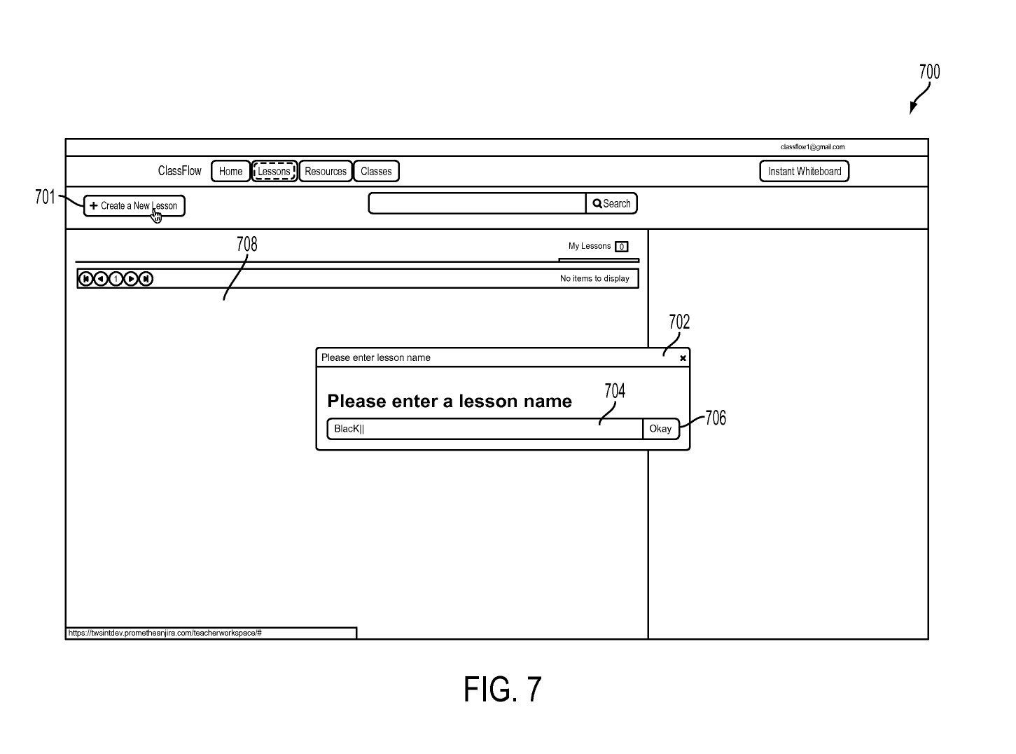

FIG. 7 depicts a Lesson Name Screen 700, which enables a user to enter a name for a specific lesson. According to various embodiments, the Lesson Name Screen 700 may be accessed by the teacher by selecting Lessons from the navigation options 602 referenced above. Here, the teacher may create a lesson that is associated with the class, as discussed above. In this way, the teacher may create a series of lessons associated with each class. In one or more embodiments, the teacher (or another presenter) may create a one-time use lesson for a specific lesson or presentation.

The Lesson Name Screen 700 includes a Create a New Lesson Button 701, which, when selected by the teacher displays a lesson name box 702, which includes a lesson name line 704 and a confirmation button 706. The teacher may enter a lesson name in the lesson name line 704 and then confirm the lesson name by selecting the confirmation button 706 (which may be, in various embodiments, any suitable user-selectable indicia). Once confirming the lesson name, the lesson name is populated in the lesson list 708. The teacher may then select a created lesson from the lesson list 708 to build/create the individual lesson.

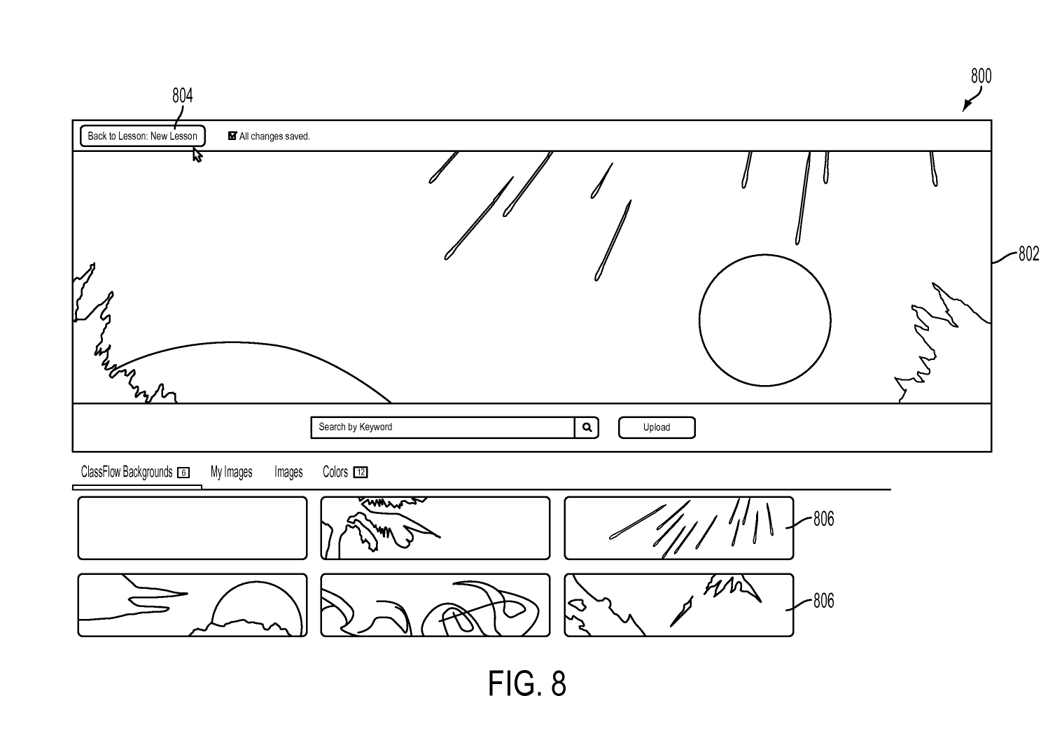

After setting up a new lesson, as described above, the teacher, in various embodiments, is prompted to select a first background for the lesson from a Background Selection Screen 800 as depicted in FIG. 8. The Background Selection Screen 800 includes a selected background 802 (e.g., a display of the background selected by the teacher), a Back to Lesson Button 804 (e.g., any suitable user-selectable indicia that enables a user to go back to a Lesson Builder Screen, as further discussed below), and any number of available backgrounds 806. The teacher may select a particular background from the selection of available backgrounds 806, which is then displayed as the selected background 802. According to various embodiments, the selected background may be used a background for more than one slide.

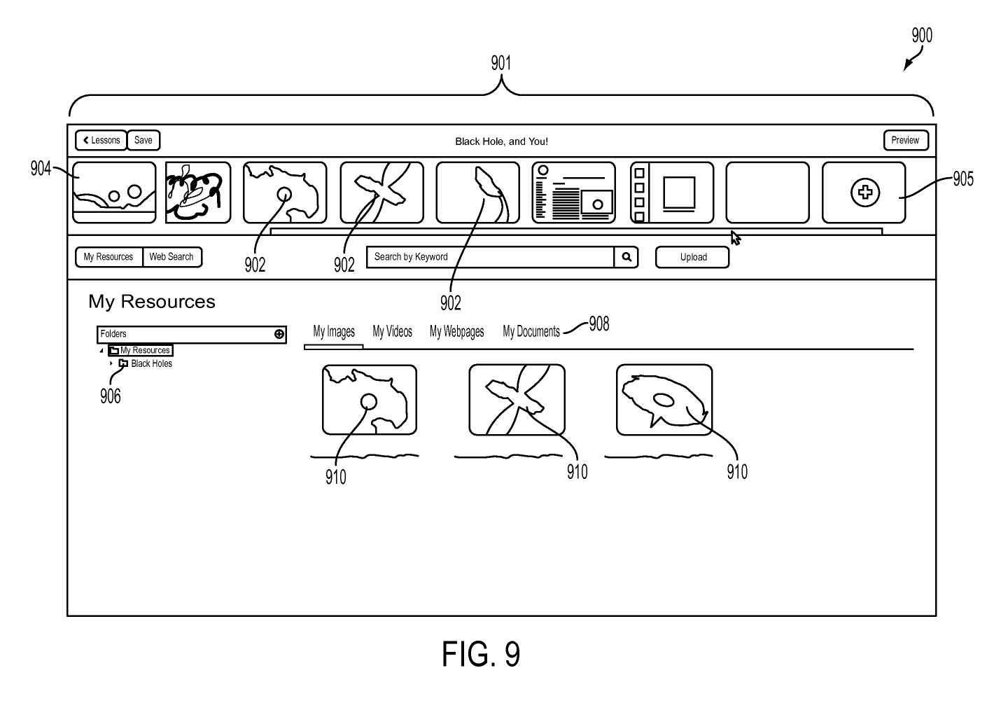

FIG. 9 depicts a Lesson Builder Screen 900 that the system displays when in a presentation builder mode. As may be understood from this Figure, the Lesson Builder Screen 900 includes a preview area 901, a folder list 906, one or more library options 908, and one or more slide images 910. The preview area 901 includes a background preview 904 (e.g., a thumbnail preview of the Selected Background 802 discussed above), a plurality of slide previews 902, and a New Slide Button 905. Generally, in various embodiments, the background preview 904 and the plurality of slide previews 902 are arranged left to right in the order in which they are to be displayed during the presentation (e.g., the furthest left slide of the plurality of slide previews 902 is to be displayed first during the presentation, the slide immediately to the right of the furthest left slide is to be displayed second, etc.). Additionally, in the embodiment shown, the background preview 902 is associated with each of the plurality of slide previews 902, such that the background that is represented by the background preview 904 is displayed as the background for each of the respective plurality of slides associated with the plurality of slide previews 902 (as further discussed below). The New Slide Button 905 allows the teacher to add a new slide to the plurality of slide previews 902 (e.g., the teacher selects the New Slide Button 905 and may then select the content for the new slide).

The teacher may use the folder list 906 and the one or more library options 908 to navigate to a desired object to add to a slide. In the embodiment shown, the teacher has navigated to the one or more slide images 910 shown in FIG. 9. The teacher may now select (in any suitable way) any of the three displayed images 910 to add to any of the slides 902 shown in the preview area 901.

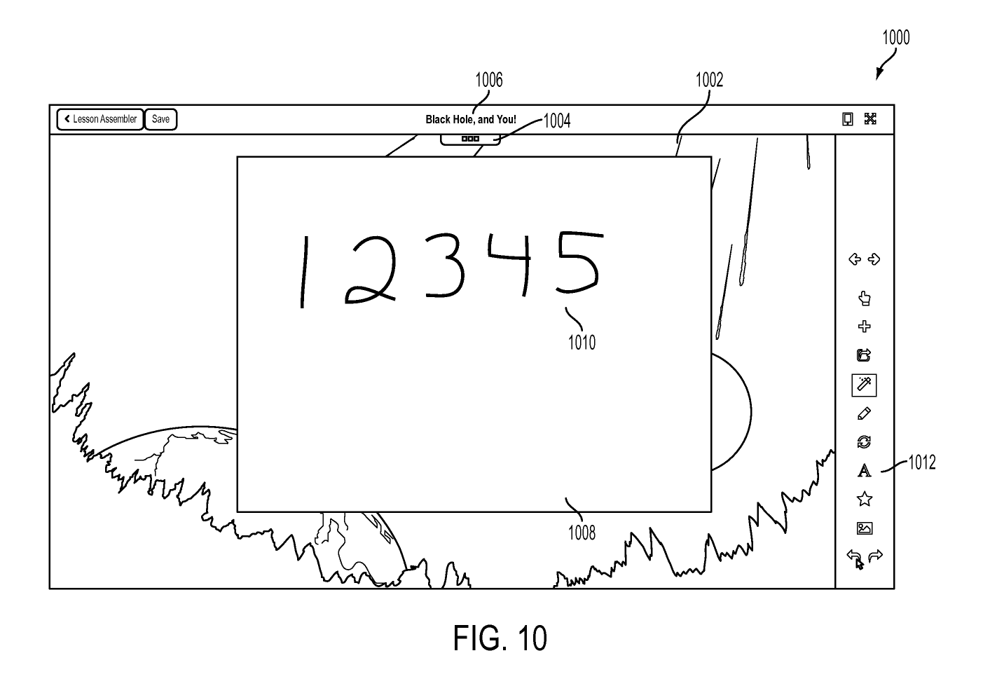

FIG. 10 depicts a Lesson Preview Screen 1000 that the teacher may use to preview how various parts of the lesson will be displayed during a presentation. As shown, the Lesson Preview Screen 1000 includes a background 1002 (which, as shown, is substantially the same as the selected background 802), a Slide Preview Area Button 1004, a lesson title 1006 (e.g., “Black Hole, and You!” as entered by the teacher above in the lesson name line 702), a slide preview 1008, a slide annotation 1010, and an editing tool bar 1012. In the embodiment shown, the slide preview 1008 is displayed over a portion of the background 1002. The teacher may select the Slide Preview Area Button 1004 to display the preview area (as generally described above). The teacher may add the slide annotation 1010 using options included with the editing tool bar 1012 (e.g., the teacher may select any number of options, such as the “A” to add text, or the user may select a pen to create an annotation (e.g., free-hand) with a suitable pointer device and/or touch input).

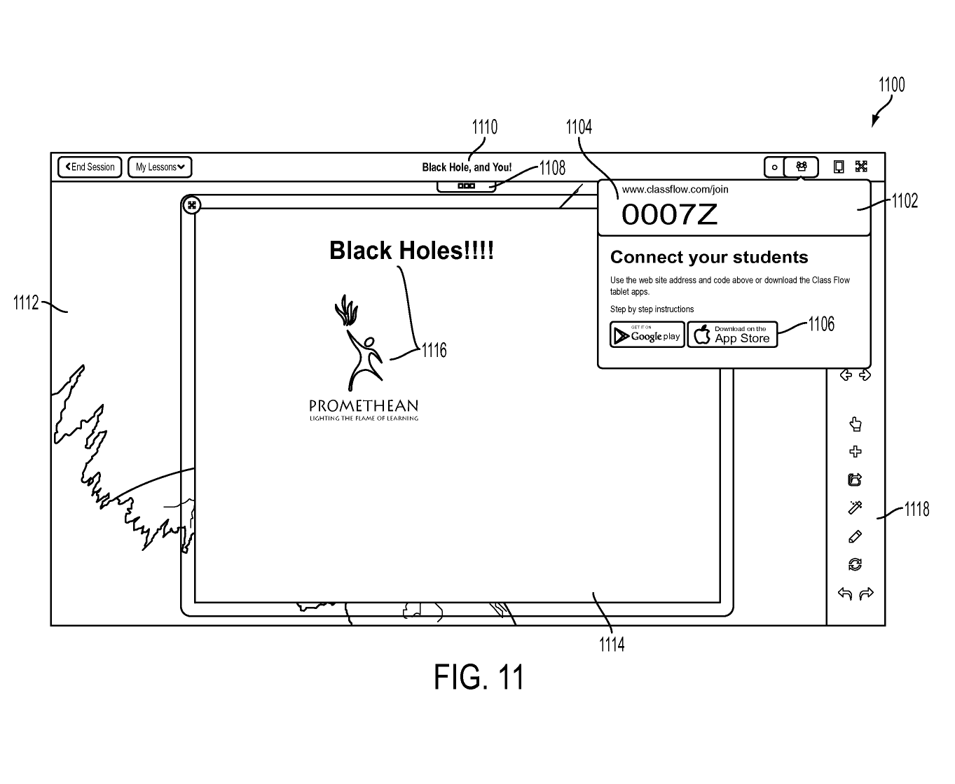

FIG. 11 depicts a Presentation Screen 1100 in which the teacher has entered a display/presentation mode. It should be understood that the Presentation Screen 1100 may be displayed in a classroom on an interactive display, on a display screen at a conference, on a display screen that is remote from the teacher/presenter, etc.

The presentation screen includes a code display 1102, a Preview Area Button 1108, a lesson title 1110, a background 1112, a slide 1114 displayed over the background 1112, one or more annotations 1116, and an editing tool bar 1118. The code display 1102 includes a class code 1104, which one or more viewers (e.g., one or more students) of the lesson may use to login in order to receive portions of the lesson on their personal computing device (e.g., the class code 630). The code display also includes one or more download options 1106, which displays one or more applications (e.g., via “Google Play”) that the one or more viewers may use to download a ClassFlow application necessary to view the presentation (e.g., the one or more viewers enters the class code 1104 into the ClassFlow application to view/receive the presentation).

The teacher may use the Preview Area Button 1108 to access the preview area, which displays a preview of the one or more backgrounds and/or one or more slides of the presentation. The teacher may additionally freely add any suitable one or more annotations 1116 to the slide 1114 via one or more tools displayed on the editing tool bar 1118.

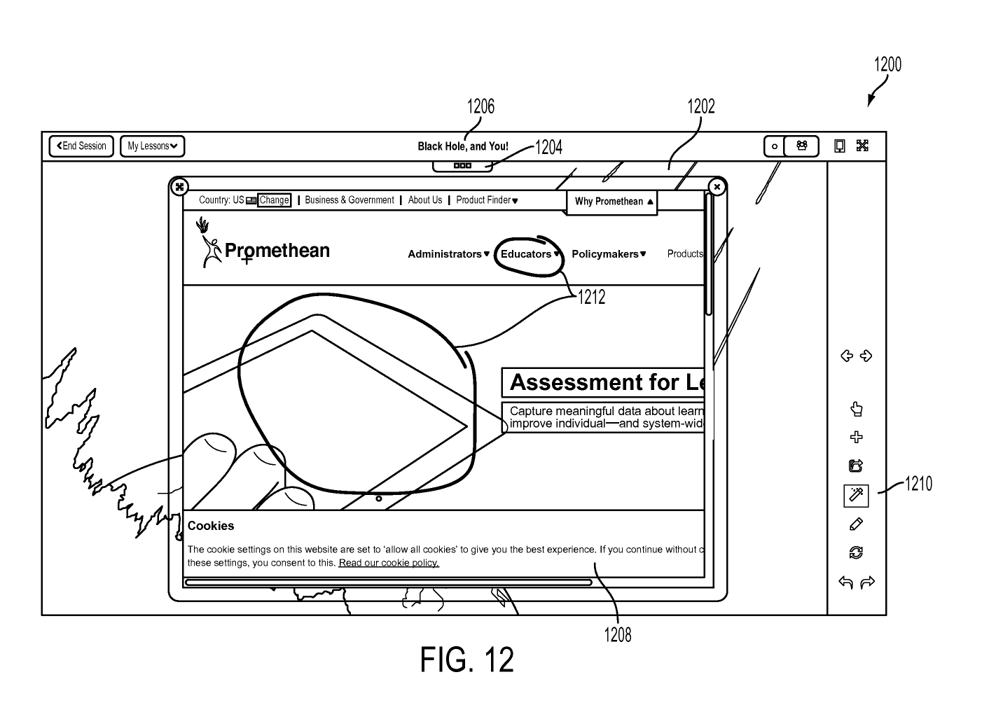

FIG. 12 depicts a Second Presentation Screen 1200 that includes a background 1202, a Preview Area Button 1204, a lesson title 1206, a slide 1208 displayed over the background 1202, one or more annotations 1212, and an editing tool bar 1210. In the embodiment shown, the slide 1208 is a slide that displays a live website (e.g., a website with live links, etc.) over the background 1202. The teacher may select a tool (e.g., a pen tool) from the editing tool bar 1210 to add the one or more annotations 1212 to the slide 1208.

FIG. 13 depicts a Third Presentation Screen 1300, which includes an editing tool bar 1314, a background 1302, a Preview Area Button 1304, a lesson title 1306, first and second slides 1308, 1310 displayed over the background 1302, and several different presenter annotations 1312, 1313 (including an annotation that extends between the first and second slides 1308, 1310). In the embodiment shown, the first slide 1308 displays a live website and the second slide 1310 displays a video that runs automatically (e.g., in a loop) when the slide is moved into the presentation display area. As shown, the video is playing and the teacher has created has created various annotations 1312 on the live website and on the video while the video is playing. In particular embodiment, the teacher may scroll through and otherwise interact with the live website during the presentation.

FIG. 14 depicts a Fourth Presentation Screen 1400, which includes a background 1402, a Preview Area Button 1404, a lesson title 1406, first and second slides 1408 and 1410 displayed over the background 1402, various presenter annotations 1412, and an editing tool bar 1414. As shown in this embodiment, the teacher arranges the first slide 1408 to partially overlap top of the second slide 1410 (which demonstrates that, in various embodiments, the slides may be shown in an overlapped configuration while the system is in a presentation mode, without affecting the functionality of the slides). Additionally, the Fourth Presentation Screen 1400 depicts the first slide 1408 in a partially rotated position (e.g., the teacher has rotated the slide 1408 while presenting the slide 1408). As may be understood from this figure, in various embodiments, the system is adapted to allow a user to rotate slides in real time while the system is in a presentation mode, without affecting the content of the slide (e.g., without stopping the payback of a video that is playing on the slide).

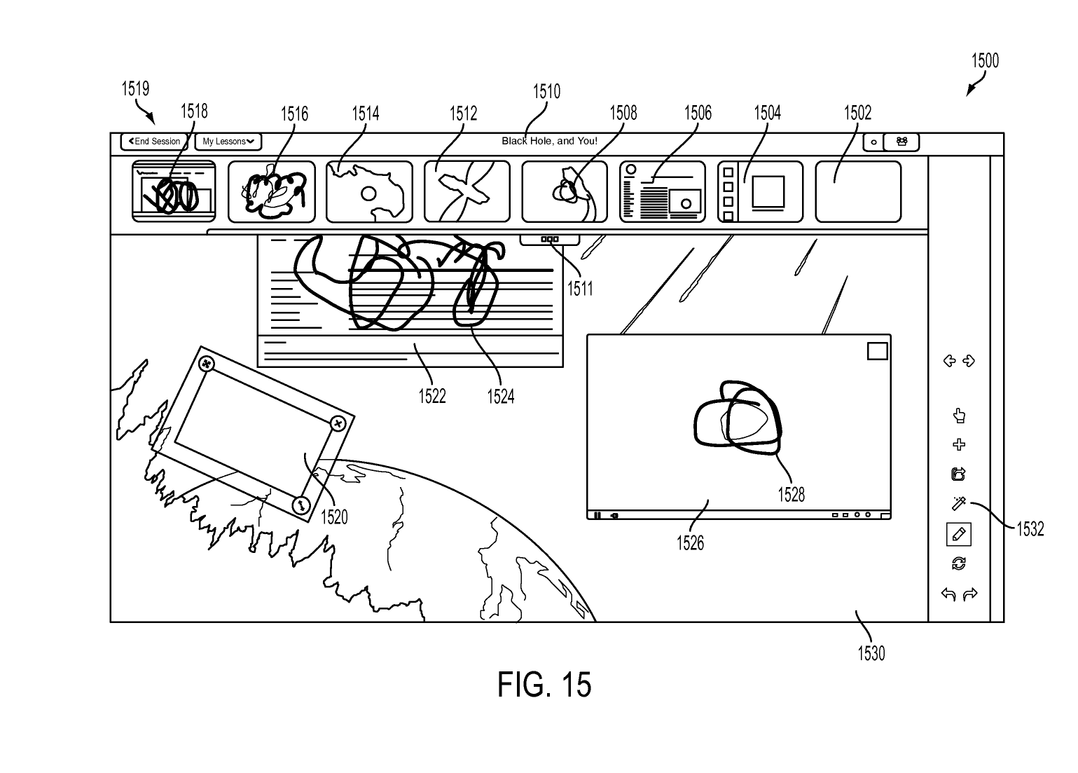

FIG. 15 depicts a Fifth Presentation Screen 1500, which includes: (1) a lesson title 1510; (2) a preview area button 1511; (3) a slide preview area 1519 that includes various slide previews 1502, 1504, 1506, 1508, 1512, 1514, 1516, and 1518; (4) first, second and third slides 1520, 1522, 1526 displayed over a background 1530; (5) various presenter annotations 1524, 1528; and (6) and an editing tool bar 1532. As shown in the present embodiment, the teacher has selected the preview area button 1511 revealing the slide preview area 1519. The slide preview area 1519 includes live previews of the various slides that make up the current presentation (e.g., as a slide changes during a presentation, the respective slide preview reflects the one or more changes to the slide, such as, a video playing, a slide animation changing, annotation being added to the slide, etc.).

The Fifth Presentation Screen 1500 depicts the first slide 1520 in a rotated position and the second and third slides 1522 and 1526 in a normal, non-rotated, position. The second slide 1522 displays a live website and the third slide 1526 displays a video, which is playing. As shown in this figure, the teacher has created multiple annotations 1524 and 1528 over the slides using the editing tool bar 1532.

### CONCLUSION

Many modifications and other embodiments of the invention will come to mind to one skilled in the art to which this invention pertains having the benefit of the teachings presented in the foregoing descriptions and the associated drawings. While examples discussed above cover the use of the invention in the context of a presentation, the invention may be used in any other suitable context, such as within the context of: (1) a webinar; (2) online classes; (3) conferences; (4) advertising/advertising displays; and/or (5) any other suitable system for displaying and/or annotating content. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

We claim:

1. A computer system for enabling a user to create a presentation, the computer system comprising:
at least one processor; and
memory, wherein the computer system is configured for:
a. accessing a presentation that includes both a first slide and a second slide, the first and second slides each defining a respective object display area, and each of said first and second slides being adapted to selectively display a plurality of different multimedia objects within its respective object display area;
b. receiving a display request, from a user, to display the first and second slides in a common slide display area of the presentation;
c. at least partially in response to receiving the display request, simultaneously displaying the first and second slides within the presentation's slide display area; and
d. while displaying the first and second slides within the slide display area, allowing a user to annotate the first and second slides.

2. The system of claim 1, wherein the system is adapted to allow a user to annotate the first and second slides by moving a pointing device relative to a display of said first and second slides.

3. The system of claim 2, wherein said pointing device is a device selected from a group consisting of: the user's finger, a stylus, a computer mouse, and a joystick.

4. The system of claim 1, wherein the system is adapted to allow a user to make one or more annotations on the first slide by drawing within the first slide's object display area.

5. The system of claim 4, wherein the system is adapted to:
a. save the one or more annotations; and
b. display the one or more annotations along with the first slide in a later presentation.

6. The system of claim 4, wherein the system is adapted to allow a user to make one or more annotations on the second slide by drawing within the second slide's object display area.

7. The system of claim 1, wherein the system is adapted to allow a user to annotate the first and second slides by making one or more drawing annotations that extend between the first and second slides.

8. The system of claim 7, wherein the system is adapted to allow a user to annotate the first and second slides by making at least one drawing annotation that extends between the first and second slides on a display screen.

9. The system of claim 8, wherein the at least one drawing annotation extends over: (1) the object display area of the first slide; (2) an area that is outside both the object display area of the first slide and the object display area of the second slide; and (3) the object display area of the second slide.

10. The system of claim 9, wherein the system is configured to:
a. save the at least one drawing annotation; and
b. display the at least one drawing annotation along with the first and second slides in a later presentation.

11. The system of claim 1, wherein the system is configured to allow a user to rotate the first slide in real time during the presentation while the first slide is being displayed within the slide display area.

12. The system of claim 1, wherein the system is configured to allow a user to rotate the first slide independently of the second slide during the presentation while both the first slide and the second slide are being displayed within the slide display area.

13. The system of claim 1, wherein the system is configured to allow a user to rotate the first slide in real time during the presentation while the first slide is being displayed within the slide display area.

14. The system of claim 1, wherein the system is configured to allow a user to simultaneously rotate both the first slide and the second slide during the presentation while both the first slide and the second slide are being displayed within the slide display area.

15. The system of claim 1, wherein the system is configured to allow a user to resize the first slide in real time during the presentation while the first slide is being displayed within the slide display area.

16. The system of claim 1, wherein the system is configured to allow a user to resize the first slide independently of the second slide during the presentation while both the first slide and the second slide are being displayed within the slide display area.

17. The system of claim 1, wherein the system is configured for, during the presentation, allowing a user to selectively move the first slide from a first location that is outside of the presentation's slide display area to a second location that is inside the presentation's slide display area.

18. The system of claim 17, wherein, when the first slide is in the first location, the first slide is positioned within a slide preview area adjacent at least a portion of the slide presentation area.

19. The system of claim 18, wherein the slide preview area includes a slide carousel that indicates, via the relative positions of a plurality of slides within the carousel, the relative order in which the plurality of slides are intended to be displayed over the course of the presentation.

20. The system of claim 19, wherein the first location is a location of the slide within the slide carousel which serves to communicate the relative order in which the plurality of slides are intended to be displayed over the course of the presentation.

21. The system of claim 1, wherein the system is configured for, during the presentation, allowing a user to selectively move the first slide from a first location that is inside the presentation's slide display area to a second location that is outside of the presentation's slide display area.

22. The system of claim 21, wherein, when the first slide is in the second location, the first slide is positioned within a slide preview area adjacent at least a portion of the slide presentation area.

23. The system of claim 22, wherein the slide preview area includes a slide carousel that indicates, via the relative positions of a plurality of slides within the carousel, the relative order in which the slides are intended to be displayed over the course of the presentation.

24. A computer-implemented method comprising:
a. accessing, by a computer processor, a presentation that includes both a first slide and a second slide, the first and second slides each defining a respective object display area, and each being adapted to selectively display a plurality of different multimedia objects within its respective object display area;
b. receiving a display request, from a user, to display the first and second slides in a common slide display area of the presentation; and
c. at least partially in response to receiving the display request, simultaneously displaying the first and second slides within the presentation's slide display area; and
d. while displaying the first and second slides within the slide display area, allowing a user to annotate the first and second slides.

25. A non-transitory computer readable medium comprising computer-executable instructions for:
a. accessing a presentation that includes both a first slide and a second slide, the first and second slides each defining a respective object display area, and each being adapted to selectively display a plurality of different multimedia objects within its respective object display area;
b. receiving a display request, from a user, to display the first and second slides in a common slide display area of the presentation; and
c. at least partially in response to receiving the display request, simultaneously displaying the first and second slides within the presentation's slide display area; and
d. while displaying the first and second slides within the slide display area, allowing a user to annotate the first and second slides.

26. A computer system for enabling a user to create a presentation, the computer system comprising:
at least one processor; and
memory, wherein the computer system is configured for:
a. accessing a presentation that includes both a first slide and a second slide, the first and second slides each defining a respective object display area, and each being adapted to selectively display a plurality of different multimedia objects within its respective object display area;
b. receiving a display request, from a user, to display the first and second slides in a common slide display area of the presentation;
c. at least partially in response to receiving the display request, simultaneously displaying the first and second slides within the presentation's slide display area; and
d. while displaying the first and second slides within the slide display area, allowing a user to take an action selected from a group consisting of:
i. annotating the first and second slides;
ii. independently rotating and/or resizing one or more of the first and second slides;
iii. removing the first slide from the slide display area independently of the second slide; and
iv. adding one or more additional slides to the slide display area.

27. The computer system of claim 26, wherein said action is annotating the first and second slides.

28. The computer system of claim 26, wherein said action is independently rotating at least one of the first and second slides.

29. The computer system of claim 26, wherein said action is independently resizing at least one of the first and second slides.

30. The computer system of claim 26, wherein said action is removing the first slide from the slide display area independently of the second slide.

31. The computer system of claim 26, wherein said action is adding one or more additional slides to the slide display area.
